(19) United States
(12) Patent Application Publication
(10) Pub. No.: US 2019/0184791 A1
(43) Pub. Date: Jun. 20, 2019

(54) Pressure Relief Assembly Having Latchable Cover

(71) Applicant: ILLINOIS TOOL WORKS INC., Glenview, IL (US)

(72) Inventors: Timothy M. Barnes, Leominster, MA (US); James F. Fleck, Warren, MI (US); Tyler M. Letherwood, Northville, MI (US)

(21) Appl. No.: 16/327,978

(22) PCT Filed: Aug. 18, 2017
(86) PCT No.: PCT/US2017/047475

§ 371 Date: Feb. 25, 2019

Related U.S. Application Data
(60) Provisional application No. 62/381,652, filed on Aug. 31, 2016.

(51) Int. Cl. B60H 1/24

(52) U.S. Cl. CPC B60H 1/249

(57) ABSTRACT

A pressure relief assembly includes a main body (100) including at least one air passage chamber defined between one or more outer walls. At least one flap (320) covers at least one air opening within the air passage chamber(s). The outer wall(s) include one or more first latch members (120). A cover (200) includes one or more second latch members (202) that are configured to securely latch to the first latch member(s).

### RELATED APPLICATIONS

This application relates to and claims priority benefits from U.S. Provisional Patent Application No. 62/381,652, entitled “Pressure Relief Assembly Having Latchable Cover,” filed Aug. 31, 2016, which is hereby incorporated by reference in its entirety.

### FIELD OF EMBODIMENTS OF THE DISCLOSURE

Embodiments of the present disclosure generally relate to a venting or pressure relief device configured for use in an enclosed area, such as an automobile, and more to a pressure relief assembly that includes a cover that latchably secures to a main body or housing.

### BACKGROUND

Interior cabins of vehicles typically include cabin vents or pressure relief devices. Without such devices, air pressure inside the vehicle cabin could damage occupants' ear drums. Further, when a vehicle door is closed, air pressure within the vehicle needs to be relieved or the door will not close. If an air bag is activated in a vehicle that does not have a venting or pressure relief device, an occupant's ear drums may be damaged.

Pressure relief devices are usually hidden from view. For example, a pressure relief device may be found in a trunk or on a body frame pillar structure. Each pressure relief device is adapted to allow air to pass out of an enclosed structure, while also preventing a significant amount of air, dust, water or other contaminants into the enclosed area. Thus, pressure relief devices are, in essence, one-way valves or one-way check valves, and are configured to maintain a small amount of back pressure per customer specifications.

A conventional pressure relief device includes a plastic housing having a plurality of air passages. A light membrane is positioned over the air passages, and is configured to allow air to pass in one direction. In order to allow air to pass, the light membrane opens off of the main body in response to air flow. Typically, a seal is provided around the main body and acts to seal the hole in the mating structure upon assembly. The seal is typically molded around the main body in a secondary molding operation, or may be adhesively or chemically attached to the main body.

During installation, the pressure relief device may be snap fit to a structure. Typically, a user presses on the four corners of the pressure relief device in order to secure it within a reciprocal hole in a structure, such as a frame or sheet within a vehicle.

A cover may be secured over a main body of a pressure relief assembly. The cover is used to prevent debris, moisture, and the like from passing into and through the pressure relief assembly. Further, the cover may be configured to dampen noise.

Typically, a pressure relief assembly that includes a cover is larger than one without a cover. For example, a connecting interface between the cover and the main body generally adds height to the pressure relief assembly, as the cover is secured over the main body. The increased height of the pressure relief assembly may not be well suited to fit within certain areas of a vehicle.

Further, the connecting interface may include components that outwardly project from the main body. The components may include projecting beams that may be damaged, such as by being snapped or cracked, during handling and assembly.

### SUMMARY OF EMBODIMENTS OF THE DISCLOSURE

A need exists for a pressure relief assembly including a main body and a cover that secure to one another via a low profile interface. Further, a need exists for a pressure relief assembly having a cover secured to a main body that has a reduced height as compared to known assemblies. Additionally, a need exists for a pressure relief assembly including a cover that is less susceptible to being damaged during handling.

With those needs in mind, certain embodiments of the present disclosure provide a pressure relief assembly that includes a main body including at least one air passage chamber defined between one or more outer walls. At least one flap covers at least one air opening within the air passage chamber(s). The outer wall(s) include one or more first latch members. A cover includes one or more second latch members that are configured to securely latch to the first latch member(s). In at least one embodiment, the first latch member(s) are disposed outside of one or more airflow openings within the air passage chamber(s).

The first latch members may include four first latch members (such as proximate to four corners), and the second latch members may include four corresponding second latch members. Four corner latch members provide a secure and stable connection between the main body and the cover.

In at least one embodiment, wherein the first latch member(s) are contained by the outer wall(s). For example, the first latch member(s) do not extend over exposed edges of the outer wall(s), and do not extend past outer surfaces of the outer wall(s). The first latch member(s) may inwardly extend from at least one interior surface of the outer wall(s) into the air passage chamber(s).

In at least one embodiment, the first latch member(s) include a protuberance having a latching recess. At least a portion of the second latch member(s) passes into the latching recess. The latching recess may connect to an underside ridge onto which the second latch member(s) latch.

The main body may also include one or more panel-securing members that are configured to secure the main body within an opening of a panel.

In at least one embodiment, the second latch member(s) include a beveled tab extending from an inner surface of the cover. The beveled tab includes an expanded base proximate to the inner surface and a narrowed expanded end distally away from the inner surface. The exposed end includes a protruding clip that is configured to securely latch to the first latch member(s).

In at least one embodiment, one or more latch interfaces between the one first latch member(s) and second latch member(s) are underneath flap hinge area(s) of the main body.

### BRIEF DESCRIPTION OF SEVERAL VIEWS OF THE DRAWINGS

FIG. 1 illustrates a perspective view of a main body of a pressure relief assembly, according to an embodiment of the present disclosure.

FIG. 2 illustrates a perspective interior view of a cover of a pressure relief assembly, according to an embodiment of the present disclosure.

FIG. 3 illustrates a cross-sectional view of a pressure relief assembly including a cover securely coupled to a main body, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide a pressure relief assembly that includes a main body or housing and a cover that is configured to be latchably secured to the main body. The main body includes latch members that may be akin to wire channel latches. The latch members may be formed in a die draw of the main body and/or the cover, thereby eliminating or otherwise reducing the need for expensive side action tooling.

Reciprocal latch members on the cover are low profile, and minimize or otherwise reduce the potential for being damaged, such as when being handled. The latch interfaces between the main body and the cover may be in low airflow areas of the pressure relief assembly. As such, the latch interfaces generally do not (or minimally) affect airflow through the pressure relief assembly. For example, upper latches may be under a flap hinge, while lower latches may be located in a scoop of the main body. Further, during assembly, the latch members of the main body engage the reciprocal latch members of the cover with little to no increase in assembly force.

Pressure relief assemblies having covers are disclosed in PCT/US2017/022087, entitled “Impact-Absorbing Pressure Relief Assembly Having Cover,” which was filed Mar. 13, 2017, and is hereby incorporated by reference in its entirety. Pressure relief assemblies are also shown and described in U.S. Application Publication No. 2010/0243083, entitled “Pressure Relief Assembly,” which is also hereby incorporated by reference in its entirety.

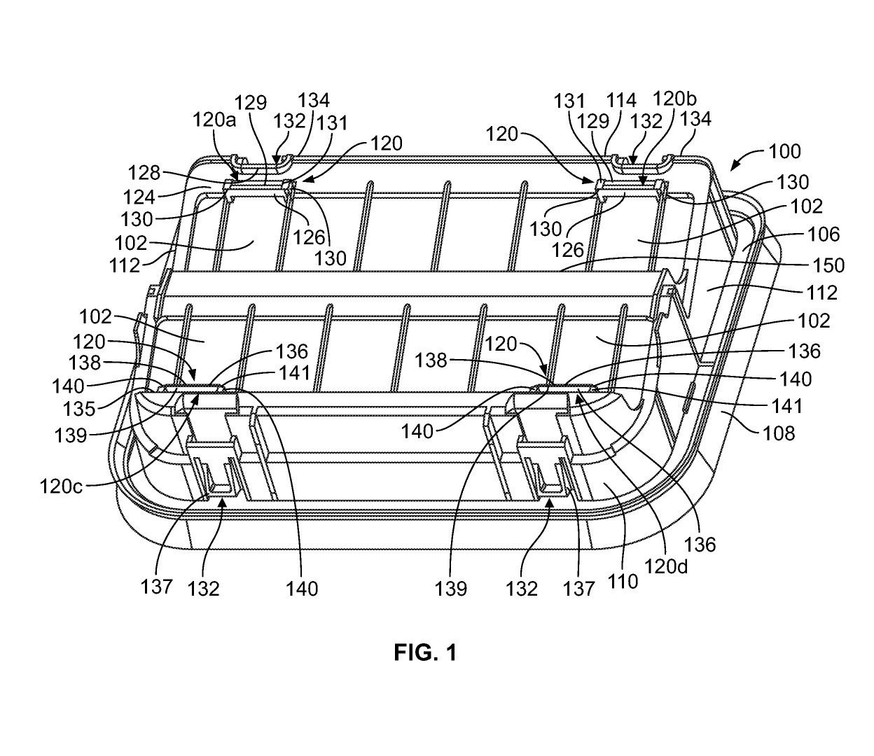

FIG. 1 illustrates a perspective view of a housing or main body 100 of a pressure relief assembly, according to an embodiment of the present disclosure. A cover (not shown in FIG. 1) is configured to secure over the main body 100 to form the pressure relief assembly. The pressure relief assembly is configured to secure to a component, such as a panel of sheet metal of a vehicle, for example. The pressure relief assembly secures into an opening formed through the panel. For example, the pressure relief assembly snapably secures into the opening formed through the panel. The cover then secures over the main body 100.

The main body 100 may be formed of a plastic, such as acrylic. In at least one embodiment, the main body 100 is formed of injection-molded polypropylene. The main body 100 may be formed through a thermoforming process, which is generally an efficient and economical way of making various plastic devices. During the manufacturing process, a roll of plastic may be fed into a cavity, and then the plastic is formed using heat and pressure.

The main body 100 includes a plurality of air passage chambers 102 that define airflow openings. Flaps secure in the air passage chambers 102 over the airflow openings. The main body 100 may include more or less air passage chambers 102 than shown. Instead of a plurality of air passage chambers 102, the main body 100 may include a single air passage chamber. Also, optionally, the air passages 102 may be coplanar with a flat base, instead of being angled (as shown in FIG. 1).

The main body 100 includes a base 106, onto and/or around which a seal 108 may be secured. The seal 108 may be formed of an elastomeric material and is configured to sealingly engage to the panel around the opening.

The air passage chambers 102 are defined between one or more outer walls, such as a lower wall 110 integrally connected to an upper wall 114 by lateral walls 112. Optionally, the outer walls may include more or less than four wall portions. For example, three outer walls in the shape of a triangle may define the air passage chambers 102 therebetween. As another example, a s single, circular outer wall may define the air passage chambers 102 therebetween.

In at least one embodiment, and as shown in FIG. 1, a first or lower wall 110 integrally connects to lateral (for example, second and third) walls 112, which, in turn integrally connect to an upper or fourth wall 114. The terms first, second, third, and fourth are used to identify the number of walls extending from the base 106. It is to be understood that the first wall may be considered a second, third, or fourth wall, and vice versa. The lower wall 110, the lateral walls 112 and the upper wall 114 outwardly extend (upwardly, as shown in FIG. 1) from the base 106. The air passage chambers 102 are defined between the lower wall 110, the lateral walls 112 and the upper wall 114.

In closed positions, the flaps cover airflow openings within the air passage chambers 102. Each flap may be anchored to the main body 100. For example, each flap may mount to the main body 100 through first attachments, such as connecting posts, which outwardly extend above the airflow openings defined by the air passage chambers 102. The flaps may be formed of a flexible thermoplastic elastomer, such as ethylene propylene diene monomer (EPDM) rubber, polypropylene, Hytrel, Lexan, Tyvac or Mylar, for example.

In at-rest positions, the flaps cover the airflow openings. As air pressure builds and is exerted into undersides of the flaps, the flaps pivotally flap open so that the airflow openings are exposed, thereby allowing air to vent through the pressure relief assembly.

The main body 100 also includes one or more latch members 120 that are configured to mate with reciprocal latch members of a cover in order to latchably secure the cover to the main body 100. In at least one embodiment, the main body 100 includes four latch members 120. For example, the main body 100 may include latch members 120a, 120b, 120c, and 120d proximate to four corners.

The latch members 120a-d are formed on and/or in wall portions of the main body 100, such as proximate to four corner areas. Because the latch members are formed on and/or in the wall portions, the latch members do not outwardly protrude from the main body 100. The outer walls (for example, the lower wall 110, the lateral walls 112, and the upper wall 114) of the main body 100 contain the latch members 120a-d. That is, the latch members 120a-d do not extend above upper edges of the outer walls, or extend past outer surfaces of the outer walls.

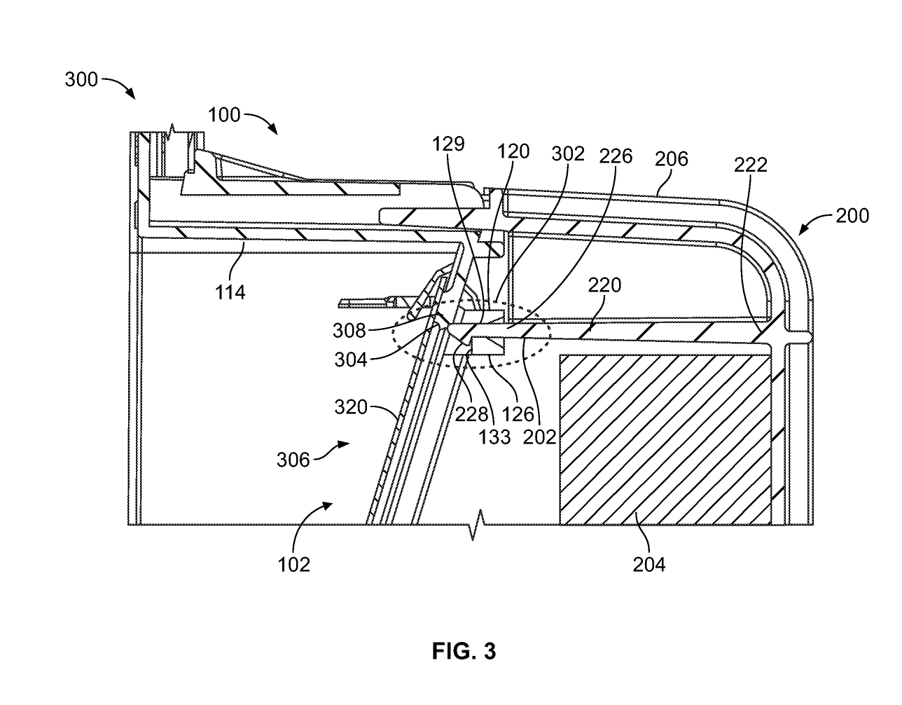

In at least one embodiment, the latch members 120a and 120b extend from interior surfaces 124 of the upper wall 114. For example, the latch members 120a and 120b may be or including protuberances 126, which may include a spanning block 128 integrally connected to lateral ends 130. Latching recesses 129 may be formed in and/or through an exposed surface 131 of the protuberances 126. The latching recesses 129 may lead to an exposed underside ridge (as shown and described with respect to FIG. 3). The protuberances 126 are configured to latchably secure to reciprocal latch members of a cover. Optionally, the protuberances 126 may be sized and shaped differently in order to securely couple to a reciprocal latch structure, depending on the size and shape of the reciprocal latch members of the cover. For example, the protuberances 126 may be or include one or more barbs, clasps, hooks, studs, tabs, slots, and/or the like.

As shown, the latch members 120a and 120b do not extend above a height of the upper wall 114. Also, the latch members 120a and 120b do not extend outwardly past the upper wall 114 or the lateral walls 112. As such, the latch members 120a and 120b are contained within the main body 100 (such as within a volume defined between the lower wall 110, the lateral walls 112 and the upper wall 114), and do not add height, length, width, or the like thereto. The latch members 120a and 120b are contained within longitudinal, lateral, and height envelopes of the main body 100. In particular, the latch members 120a and 120b do not extend above upper edges of the upper wall 114, or past outer surfaces of the upper wall 114 and the lateral walls 112. Therefore, the main body 100 provides a low profile.

Panel-securing members 132 may be formed in relation to outer surfaces 134 of the upper wall 114 opposite from the latch members 120a and 120b. The panel-securing members 132 are configured to securely clip the main body 100 to a panel. The panel-securing members 132 may also include clips that are configured to securely clip an edge of a panel between the base 106 and/or the seal 108 and the clips. The clips extend from the outer surface 134 of the upper wall 114, and are therefore located away from the latch members 120a and 120b. Accordingly, the latch members 120a and 120b do not affect the securing force of the panel-securing members 132.

The latch members 120c and 120d extend from interior surfaces 135 of the lower wall 110. For example, the latch members 120c and 120d may be protuberances 136 including a spanning block 138 integrally connected to lateral ends 140. Latching recesses 139 may be formed in and/or through an exposed surface 141 of the protuberances 136. The latching recesses 129 may lead to an exposed underside ridge (as shown and described with respect to FIG. 3). As shown, the protuberances 126 and 136 may be sized and shaped the same, but extend from different walls of the main body 100. Optionally, the protuberances 136 may be sized and shaped differently in order to securely couple to a reciprocal latch structure, depending on the size and shape of the reciprocal latch structures of the cover. For example, the protuberances 126 may be or include one or more barbs, clasps, hooks, studs, tabs, slots, and/or the like.

Similar to the latch members 120a and 120b, the latch members 120c and 120d do not extend above a height of the lower wall 110. Also, the latch members 120c and 120d do not extend outwardly past the lower wall 110 or the lateral walls 112. As such, the latch members 120c and 120d are contained within the main body 100 (such as within a volume defined between the lower wall 110, the lateral walls 112 and the upper wall 114), and do not add height, length, width, or the like thereto. The latch members 120c and 120d are contained within longitudinal, lateral, and height envelopes of the main body 100. In particular, the latch members 120c and 120d do not extend above upper edges of the upper wall 114, or past outer surfaces of the upper wall 114 and the lateral walls 112. Therefore, the main body 100 provides a low profile.

Panel-securing members 132 may extend from outer surfaces 134 of the upper wall 114 opposite from the latch members 120c and 120d. The panel-securing members 132 are configured to securely clip the main body 100 to a panel. The panel-securing members 132 may include clips 137 that are configured to securely clip an edge of a panel between the base 106 and/or the seal 108 and the clips 137. The clips 137 extend from the outer surface 134 of the upper wall 114, and are therefore located away from the interior latch members 120c and 120d. Consequently, the latch members 120c and 120d do not affect the securing force of the panel-securing members 132.

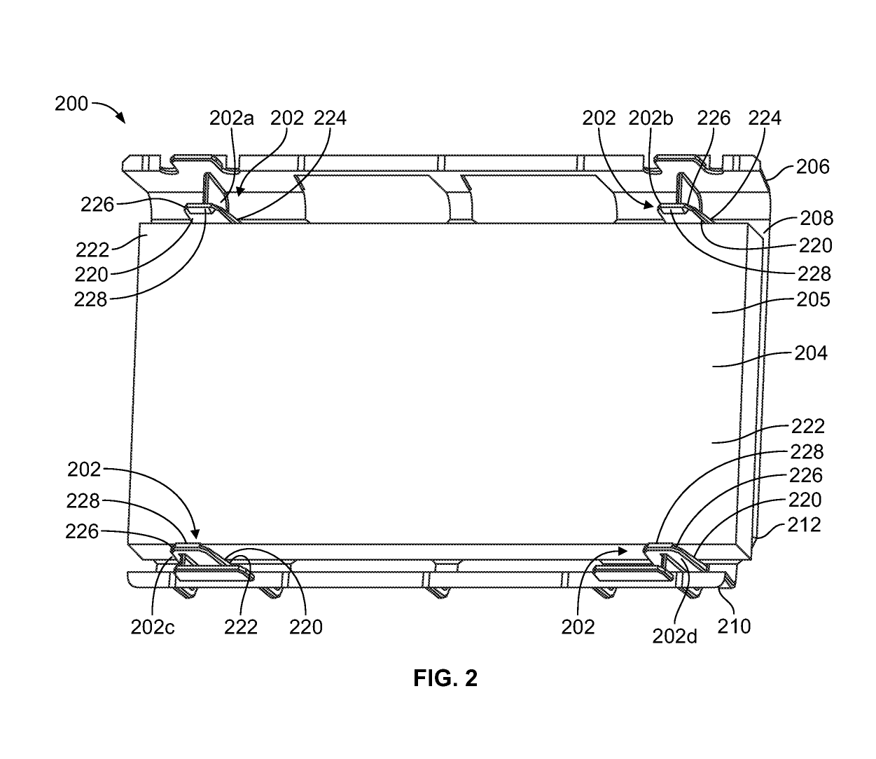

FIG. 2 illustrates a perspective interior view of a cover 200 of a pressure relief assembly, according to an embodiment of the present disclosure. The main body 100 (shown in FIG. 1) and the cover 200 couple together to form the pressure relief assembly. As shown in FIG. 2, reciprocal latch members 202 are formed at areas of the cover that coincide with the latch members 120a-d of the main body 100, as shown in FIG. 1. The cover 200 couples to the main body 100 in order to protect the components of the main body 100 (such as the flaps) from foreign objects/debris, impacts, and the like.

The cover 200 includes a covering panel 204. A sound-dampening layer 205 may extend inwardly from an inner surface 222. The sound-dampening layer 205 may be formed from open or closed cell foam, an elastomeric material, and/or the like. Optionally, the cover 200 may not include the layer 205. An upper shroud 206 extends from an upper end 208 of the covering panel 204, while a lower ledge 210 extends from a lower end 212 of the covering panel 204. It is to be understood that throughout the present disclosure, the terms upper, lower, and lateral are used in connection with the orientations as shown in the Figures. Depending on how a component is oriented, an upper portion may be a lower portion, a lateral portion, and/or the like.

Each latch member 202a-d includes a beveled tab 220 extending from the inner surface 222 of the cover 200. The beveled tabs 220 include an expanded base 224 proximate to the inner surface 222 and a narrowed exposed end 226 distally away from the inner surface 222. The exposed end 226 may include a protruding clip 228 that is configured to securely latch into a recess 129 of a counterpart latch member 120 (shown in FIG. 1). Optionally, the latch members 202a-d may be sized and shaped differently, depending on the size and shape of the counterpart latch members 120. In at least one embodiment, the latch members 202a-d shown in FIG. 2 may be sized and shapes as the latch members 120a-d shown in FIG. 1, and vice versa.

Referring to FIGS. 1 and 2, the latch members 202a-d (for example, first or second latch members 202a-d) are configured to latchably secure to the latch members 120a-d (for example, the other of first or second latch members 120a-d), respectively. Referring to FIGS. 1 and 2, the latch members 120 of the main body 100 and the reciprocal latch members 202 of the cover 200 are positioned away from (that is, outside of) main airflow areas 150 proximate to the air passage chambers 102 of the main body 100.

FIG. 3 illustrates a cross-sectional view of the pressure relief assembly 300 including the cover 200 securely coupled to the main body 100, according to an embodiment of the present disclosure. FIG. 3 shows a latch interface 302 between the main body 100 and the cover 200. The latch interface 302 may be the same or similar in relation to the couplings between the latch members 120a-d (shown in FIG. 1) and the reciprocal latch members 202a-d (shown in FIG. 2).

The latch interface 302 is recessed within a volume of space between the cover 200 and the main body 100, as opposed to an outwardly-protruding portion. Further, the latch interface 302 is underneath a flap hinge area 304, and, as such, is substantially outside of an air passage 306 of the main body 100. That is, the latch interface 302 abuts into a wall segment 308 of the air passage chamber 102 that is outside of the air passage 306. A flap 320 is configured to flap open and close about the flap hinge area 304.

As shown, the tab 220 mates with the protuberance 126 such that the protruding clip 228 is passed into the recess 129 and latches onto an exposed underside ridge 133 of the protuberance 126. In this manner, the latch member 202 securely latches to the latch member 120. Each of the latch members 202a-d (shown in FIG. 2) may securely latch to the latch members 120a-d (shown in FIG. 1) in such manner. Because the latch interfaces 302 are outside of the air passages 306, airflow is not interrupted by the latch interface 302. Alternatively, at least a portion of at least one latch interface 302 may extend into an air passage 306.

As indicated, the latch members 120 and the latch members 202 may be sized and shaped differently than shown, in order to latchably couple to one another. For example, the latch members 120 may include tabs, while the latch members 202 may include reciprocal slots, or vice versa. In at least one other embodiment, the latch members 120 and/or the latch members 202 may include various other sized and shaped detents than shown. For example, the latch members 120 may include ramps that fit within reciprocal retaining slots of the latch members 202, or vice versa.

Referring to FIGS. 1-3, the pressure relief assembly 300 includes the main body or housing 100 and the cover 200 that latchably secures to the main body 100 via one or more of the latch interfaces 302. The latch members 120 of the main body 100 may be akin to wire channel latches. The latch members 120 and 202 may be formed in a die draw of the main body 100 and/or the cover 200, thereby eliminating or otherwise reducing the need for expensive side action tooling.

The latch members 202 of the cover are low profile. For example, the latch members 202 may not extend outwardly past an exposed edge of the upper shroud 206, which may provide protection for the latch members 202. As such, the low profile latch members 202 are less susceptible to being damaged, such as when being handled. As shown in FIG. 3, in particular, the latch interfaces 302 between the main body 100 and the cover 200 may be outside of the air passages 306, in low airflow areas of the pressure relief assembly 300. As such, the latch interfaces 306 generally do not (or minimally) affect airflow through the pressure relief assembly 300. For example, upper latches may be under a flap hinge, while lower latches may be located in a scoop of the main body 100.

As described herein, embodiments of the present disclosure provide a pressure relief assembly including a main body and a cover that secure to one another via a low profile interface. Further, embodiments of the present disclosure provide a pressure relief assembly having a cover secured to a main body that has a reduced height as compared to known assemblies. Additionally, embodiments of the present disclosure provide a pressure relief assembly including a cover that is less susceptible to being damaged during handling as compared to other known pressure relief devices having covers.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

Various features of the disclosure are set forth in the following claims.

1. A pressure relief assembly comprising:
a main body including at least one air passage chamber defined between one or more outer walls, wherein at least one flap covers at least one air opening within the at least one air passage chamber, wherein the one or more outer walls include one or more first latch members; and
a cover including one or more second latch members that are configured to securely latch to the one or more first latch members.

2. The pressure relief assembly of claim 1, wherein the one or more first latch members are disposed outside of one or more airflow openings within the at least one air passage chamber.

3. The pressure relief assembly of claim 1, wherein the one or more first latch members comprises four first latch members, and wherein the one or more second latch members comprises four second latch members.

4. The pressure relief assembly of claim 1, wherein the one or more first latch members are contained by the one or more outer walls.

5. The pressure relief assembly of claim 1, wherein the one or more first latch members do not extend over an exposed edge of the one or more outer walls, and wherein the one or more first latch members do not extend past outer surfaces of the one or more outer walls.

6. The pressure relief assembly of claim 1, wherein the one or more first latch members inwardly extend from at least one interior surface of the one or more outer walls into the at least one air passage chamber.

7. The pressure relief assembly of claim 1, wherein the one or more first latch members comprise a protuberance having a latching recess, wherein at least a portion of the one or more second latch members passes into the latching recess.

8. The pressure relief assembly of claim 7, wherein the latching recess connects to an underside ridge onto which the one or more second latch members latch.

9. The pressure relief assembly of claim 1, wherein the main body further comprises one or more panel-securing members that are configured to secure the main body within an opening of a panel.

10. The pressure relief assembly of claim 1, wherein the one or more second latch members comprises a beveled tab extending from an inner surface of the cover, wherein the beveled tab includes an expanded base proximate to the inner surface and a narrowed expanded end distally away from the inner surface, wherein the exposed end includes a protruding clip that is configured to securely latch to the one or more first latch members.

11. The pressure relief assembly of claim 1, wherein one or more latch interfaces between the one or more first latch members and the one or more second latch members are underneath one or more flap hinge areas of the main body.

12. A pressure relief assembly comprising:
a main body including at least one air passage chamber defined between outer walls, wherein a plurality of flaps cover airflow openings within the at least one air passage chamber, wherein the outer walls include a plurality of first latch members, wherein the plurality of first latch members are disposed outside of one or more airflow openings within the at least one air passage chamber; and
a cover including a plurality of second latch members that are configured to securely latch to the plurality of first latch members, wherein latch interfaces between the plurality of first latch members and the plurality of second latch members are underneath flap hinge areas of the main body.

13. The pressure relief assembly of claim 12, wherein the plurality of first latch members are contained by the outer walls.

14. The pressure relief assembly of claim 12, wherein the plurality of first latch members do not extend over exposed edges of the outer walls, and wherein the plurality of first latch members do not extend past outer surfaces of the outer walls.

15. The pressure relief assembly of claim 12, wherein the plurality of first latch members inwardly extend from interior surfaces of the outer walls into the at least one air passage chamber.

16. The pressure relief assembly of claim 12, wherein each of the plurality of first latch members comprises a protuberance having a latching recess, wherein at least a portion of each of the plurality of second latch members passes into a respective one of the latching recesses.

17. The pressure relief assembly of claim 16, wherein the latching recess connects to an underside ridge.

18. The pressure relief assembly of claim 12, wherein the main body further comprises a plurality of panel-securing members that are configured to secure the main body within an opening of a panel.

19. The pressure relief assembly of claim 1, wherein each of the plurality of second latch members comprises a beveled tab extending from an inner surface of the cover, wherein the beveled tab includes an expanded base proximate to the inner surface and a narrowed expanded end distally away from the inner surface, wherein the exposed end includes a protruding clip that is configured to securely latch to one of the plurality of first latch members.

20. A pressure relief assembly comprising:
a main body including at least one air passage chamber defined between outer walls, wherein a plurality of flaps cover airflow openings within the at least one air passage chamber, wherein the outer walls include a plurality of first latch members, wherein the plurality of first latch members are disposed outside of the airflow openings, wherein the plurality of first latch members inwardly extend from interior surfaces of the outer walls into the at least one air passage chamber, wherein the plurality of first latch members are contained by the outer walls, wherein the plurality of first latch members do not extend over exposed edges of the outer walls, wherein the plurality of first latch members do not extend past outer surfaces of the outer walls, wherein each of the plurality of first latch members comprises a protuberance having a latching recess that connects to an underside ridge, and wherein the main body further comprises a plurality of panel-securing members that are configured to secure the main body within an opening of a panel; and
a cover including a plurality of second latch members that are configured to securely latch to the plurality of first latch members, wherein at least a portion of each of the plurality of second latch members passes into the latching recess and is latched onto the underside ridge, wherein each of the plurality of second latch members comprises a beveled tab extending from an inner surface of the cover, wherein the beveled tab includes an expanded base proximate to the inner surface and a narrowed expanded end distally away from the inner surface, wherein the exposed end include a protruding clip that is configured to securely latch onto the underside ridge, and wherein a plurality of latch interfaces between the plurality of first latch members and the plurality of second latch members are underneath flap hinge areas.
